(19) United States
(12) Patent Application Publication
(10) Pub. No.: US 2005/0116875 A1
(43) Pub. Date: Jun. 2, 2005

(54) Antenna device suitable for miniaturization

(75) Inventors: Dou Yuanzhu, Fukushima-ken (JP); Tomotaka Suzuki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/995,440

(22) Filed: Nov. 23, 2004

(30) Foreign Application Priority Data
Nov. 28, 2003 (JP) 2003-398601

(51) Int. Cl. H01Q 1/48

(52) U.S. Cl. 343/846; 343/700 MS

(57) ABSTRACT

An antenna device includes a ground conductor plate composed of a metal plate and a radiating conductor plate composed of a metal plate and arranged at a predetermined gap from the ground conductor plate. First extending portions are provided in the radiating conductor plate to extend toward the ground conductor plate, and/or second extending portions are provided in the ground conductor plate to extend toward the radiating conductor plate. Capacitance is formed between the first extending portions and the ground conductor plate, between the second extending portions and the radiating conductor plate, or the first extending portions and the second extending portions respectively.

### BACKGROUND OF THE INVENTION

1. Field of the Invention

The present invention relates to a patch antenna device suitable for a GPS antenna and the like.

2. Description of the Related Art

A conventional antenna device will be described with reference to the accompanying figures. FIG. 13 is a plan view of the conventional antenna device, and FIG. 14 is a cross-sectional view illustrating the main parts of the conventional antenna device.

Next, the structure of the conventional antenna device will be described with reference to FIGS. 13 and 14. The conventional antenna device comprises a ground conductor 52 patterned on an insulating substrate 51, a radiating conductor plate 53 composed of a metal plate and arranged parallel to the ground conductor 52 at a predetermined gap therefrom, and four supporting members 54 made of a dielectric material and provided on the ground conductor 52.

Further, the radiating conductor plate 53 has a square shape, and four corners thereof where a strong electric field is applied are supported by the supporting members 54. In addition, a feeding portion 55 composed of an electrically conductive wire is connected to the radiating conductor plate 53, and the feeding portion 55 passes through the ground conductor 52 and the insulating substrate 51 through a hole 56 to be connected to an antenna circuit (not shown) (for example, see Japanese Unexamined Patent Application Publication No. 2002-237714).

However, in the conventional antenna device, a dielectric loss occurs by the four supporting members 54 where a strong electric field is applied, which results in the lowering of antenna efficiency. In addition, since the four supporting members 54 made of a dielectric material are arranged between the ground conductor 52 and the radiating conductor plate 53, a material cost or an assembling cost therefor increases, resulting in an increase in manufacturing costs.

Further, since the radiating conductor plate 53 has a rectangular shape, the size thereof increases, which is not suitable for miniaturization.

Therefore, the conventional antenna device has problems in that a dielectric loss occurs by the four supporting members 54 where a strong electric field is applied, which results in the lowering of antenna efficiency, and in that, since the four supporting members 54 made of a dielectric material are arranged between the ground conductor 52 and the radiating conductor plate 53, a material cost or an assembling cost therefor increases, resulting in an increase in manufacturing costs.

Further, the conventional antenna device has a problem in that, since the radiating conductor plate 53 has a rectangular shape, the size thereof increases, which is not suitable for miniaturization.

### SUMMARY OF THE INVENTION

Accordingly, the present invention is designed to solve the above problems, and it is an object of the present invention to provide an antenna device having a small-sized radiating conductor plate, a low dielectric loss, and a low manufacturing cost.

According to a first aspect to solve the above-mentioned problems, the present invention provides an antenna device comprising: a ground conductor plate composed of a metal plate, and a radiating conductor plate composed of a metal plate and arranged at a predetermined gap from the ground conductor plate. In the antenna device, a plurality of first extending portions is provided in the radiating conductor plate to extend toward the ground conductor plate, and/or a plurality of second extending portions is provided in the ground conductor plate to extend toward the radiating conductor plate. In addition, capacitance is formed between the first extending portions and the ground plate, between the second extending portions and the radiating conductor plate, or between the first extending portions and the second extending portions, respectively.

According to a second aspect of the present invention, preferably, the first extending portions each have a leg portion extending from the radiating conductor plate toward the ground conductor plate and an electrode portion provided at an end portion of the leg portion to extend substantially parallel to the ground conductor plate.

Further, according to a third aspect of the present invention, the leg portions of the first extending portions are provided along the outer circumference of the radiating conductor plate.

Furthermore, according to a fourth aspect of the present invention, the leg portions of the first extending portions are formed by cutting and bending at least a portion of the radiating conductor plate to be recessed from the outer circumference of the radiating conductor plate toward the center thereof.

Moreover, according to a fifth aspect of the present invention, the second extending portions each have a leg portion extending from the ground conductor plate toward the radiating conductor plate and an electrode portion provided at an end portion of the leg portion to extend substantially parallel to the radiating conductor plate.

Further, according to a sixth aspect of the present invention, the second extending portions are formed by cutting and bending the ground conductor plate.

Furthermore, according to a seventh aspect of the present invention, the antenna device further comprises chip-type capacitors each composed of a dielectric and electrodes provided on both surfaces of the dielectric, and the chip-type capacitors are arranged between the ground conductor plate and the electrode portions of the first extending portions, respectively. In addition, one electrode of each of the chip-type capacitors is connected to the respective first extending portions, and the other electrodes of the chip-type capacitors are connected to the ground conductor plate.

Moreover, according to a eighth aspect of the present invention, the antenna device further comprises chip-type capacitors each composed of a dielectric and electrodes provided on both surfaces of the dielectric, and the chip-type capacitors are arranged between the radiating conductor plate and the electrode portions of the second extending portions, respectively. In addition, one electrode of each of the chip-type capacitors is connected to the radiating conductor plate, and the other electrodes of the chip-type capacitors are connected to the respective electrode portions of the second extending portions.

Further, according to a ninth aspect of the present invention, the first extending portions each have a leg portion extending from the radiating conductor plate toward the ground conductor plate and an electrode portion provided at an end portion of the leg portion to extend substantially parallel to the ground conductor plate, and the second extending portions each have a leg portion extending from the ground conductor plate toward the radiating conductor plate and an electrode portion provided at an end portion of the leg portion to extend substantially parallel to the radiating conductor plate. In addition, the antenna device further comprises chip-type capacitors each composed of a dielectric and electrodes provided on both surfaces of the dielectric. The chip-type capacitors are arranged between the electrode portions of the first extending portions and the electrode portions of the second extending portions, respectively. Further, one electrode of each of the chip-type capacitors is connected to the respective electrode portions of the first extending portions, and the other electrodes of the chip-type capacitors are connected to the respective electrode portions of the second extending portions.

Furthermore, according to a tenth aspect of the present invention, a supporting member is provided at the center of the radiating conductor plate, and the radiating conductor plate is supported above the ground conductor plate by the supporting member.

Moreover, according to an eleventh aspect of the present invention, a circuit board having electronic components thereon is arranged between the ground conductor plate and the radiating conductor plate.

Further, according to a twelfth aspect of the present invention, the radiating conductor plate is provided with tongue pieces each formed to be bendable by a cut-out portion that is provided from the outer circumference of the radiating conductor plate toward the center thereof, and capacitance is adjusted by bending the tongue pieces.

As described above, an antenna device of the present invention comprises a ground conductor plate composed of a metal plate and a radiating conductor plate composed of a metal plate and arranged at a predetermined gap from the ground conductor plate. In the antenna device, a plurality of first extending portions is provided in the radiating conductor plate to extend toward the ground conductor plate, and/or a plurality of second extending portions is provided in the ground conductor plate to extend toward the radiating conductor plate. In addition, capacitance is formed between the first extending portions and the ground plate, between the second extending portions and the radiating conductor plate, or between the first extending portions and the second extending portions, respectively.

In this way, capacitance is formed between the ground conductor plate and the radiating conductor plate by the first extending portions or the second extending portions. Therefore, it is possible to reduce a resonance frequency and the size of the radiating conductor plate and thus to achieve an antenna device having a low manufacturing cost.

Further, since air exists between the ground conductor plate and the radiating conductor plate where the capacitance is formed, a dielectric loss does not occur, and the efficiency of an antenna is improved. Therefore, it is possible to achieve an antenna device having high performance.

Further, the first extending portions each have a leg portion extending from the radiating conductor plate toward the ground conductor plate and an electrode portion provided at an end portion of the leg portion to extend substantially parallel to the ground conductor plate. According to this simple structure, it is possible to achieve an antenna device having an increase in productivity and a low manufacturing cost. In addition, it is possible to obtain an antenna device capable of adjusting capacitance.

Furthermore, the leg portions of the first extending portions are provided along the outer circumference of the radiating conductor plate. Therefore, it is possible to obtain a radiating conductor plate having a larger surface area.

Moreover, the leg portions of the first extending portions are formed by cutting and bending at least a portion of the radiating conductor plate to be recessed from the outer circumference of the radiating conductor plate toward the center thereof. Therefore, since the leg portions each composed of a bent piece are formed by cutting and bending the outer circumference of the radiating conductor plate, it is possible to reduce a material cost and thus to manufacture an antenna device at a low cost.

Further, the second extending portions each have a leg portion extending from the ground conductor plate toward the radiating conductor plate and an electrode portion provided at an end portion of the leg portion to extend substantially parallel to the radiating conductor plate. Therefore, according to this simple structure, it is possible to achieve an antenna device having an increase in productivity and a low manufacturing cost. In addition, it is possible to obtain an antenna device capable of adjusting capacitance.

Furthermore, the second extending portions are formed by cutting and bending the ground conductor plate. Therefore, according to this simple structure, it is possible to achieve an antenna device having an increase in productivity and a low manufacturing cost.

Moreover, the antenna device further comprises chip-type capacitors each composed of a dielectric and electrodes provided on both surfaces of the dielectric, and the chip-type capacitors are arranged between the ground conductor plate and the electrode portions of the first extending portions, respectively. In addition, one electrode of each of the chip-type capacitors is connected to the respective first extending portions, and the other electrodes of the chip-type capacitors are connected to the ground conductor plate. In this way, it is possible to increase capacitance and to reduce a resonance frequency and the size of the radiating conductor plate. In addition, since the dielectric of the chip-type capacitor may be a thin dielectric plate, it is possible to greatly suppress the effects of a dielectric loss.

Further, the antenna device further comprises chip-type capacitors each composed of a dielectric and electrodes provided on both surfaces of the dielectric, and the chip-type capacitors are arranged between the radiating conductor plate and the electrode portions of the second extending portions, respectively. In addition, one electrode of each of the chip-type capacitors is connected to the radiating conductor plate, and the other electrodes of the chip-type capacitors are connected to the respective electrode portions of the second extending portions. In this way, it is possible to increase capacitance and to reduce a resonance frequency and the size of the radiating conductor plate. In addition, since the dielectric of the chip-type capacitor may be a thin dielectric plate, it is possible to greatly suppress the effects of the dielectric loss.

Furthermore, the first extending portions each have a leg portion extending from the radiating conductor plate toward the ground conductor plate and an electrode portion provided at an end portion of the leg portion to extend substantially parallel to the ground conductor plate, and the second extending portions each have a leg portion extending from the ground conductor plate toward the radiating conductor plate and an electrode portion provided at an end portion of the leg portion to extend substantially parallel to the radiating conductor plate. In addition, the antenna device further comprises chip-type capacitors each composed of a dielectric and electrodes provided on both surfaces of the dielectric. The chip-type capacitors are arranged between the electrode portions of the first extending portions and the electrode portions of the second extending portions, respectively. Further, one electrode of each of the chip-type capacitors is connected to the respective electrode portions of the first extending portions, and the other electrodes of the chip-type capacitors are connected to the respective electrode portions of the second extending portions. In this way, it is possible to increase capacitance and to reduce a resonance frequency and the size of the radiating conductor plate. In addition, since the dielectric of the chip-type capacitor may be a thin dielectric plate, it is possible to greatly suppress the effects of the dielectric loss.

Moreover, a supporting member is provided at the center of the radiating conductor plate, and the radiating conductor plate is supported above the ground conductor plate by the supporting member. Therefore, the supporting member is provided at a position where a weak electric filed is applied, and thus it is possible to suppress the effects of the dielectric loss.

Further, a circuit board having electronic components thereon is arranged between the ground conductor plate and the radiating conductor plate. Therefore, the circuit board has a good space factor, and thus it is possible to decrease the size of the circuit board.

Furthermore, the radiating conductor plate is provided with tongue pieces each formed to be bendable by a cut-out portion that is provided from the outer circumference of the radiating conductor plate toward the center thereof, and capacitance is adjusted by bending the tongue pieces. Therefore, it is possible to adjust the capacitance and thus to achieve an antenna device having high performance.

### BRIEF DESCRIPTION OF THE DRAWINGS

FIG. 1 is a plan view of an antenna device according to a first embodiment of the present invention;

FIG. 2 is a cross-sectional view taken along the line 2-2 of FIG. 1;

FIG. 3 is a cross-sectional view taken along the line 3-3 of FIG. 1;

FIG. 4 is a perspective view of a radiating conductor plate of the antenna device according to the first embodiment of the present invention;

FIG. 5 is a plan view of a radiating conductor plate of an antenna device according to a second embodiment of the present invention;

FIG. 6 is a plan view of a radiating conductor plate of an antenna device according to a third embodiment of the present invention;

FIG. 7 is a cross-sectional view taken along the line 7-7 of FIG. 6;

FIG. 8 is a perspective view of a ground conductor plate of the antenna device according to the third embodiment of the present invention;

FIG. 9 is a cross-sectional view of the main part of an antenna device according to a fourth embodiment of the present invention;

FIG. 10 is a cross-sectional view of the main part of an antenna device according to a fifth embodiment of the present invention;

FIG. 11 is a cross-sectional view of the main part of an antenna device according to a sixth embodiment of the present invention;

FIG. 12 is a cross-sectional view of the main part of an antenna device according to a seventh embodiment of the present invention;

FIG. 13 is a plan view of a conventional antenna device; and

FIG. 14 is a cross-sectional view of the main part of the conventional antenna device.

### DESCRIPTION OF THE PREFERRED EMBODIMENT

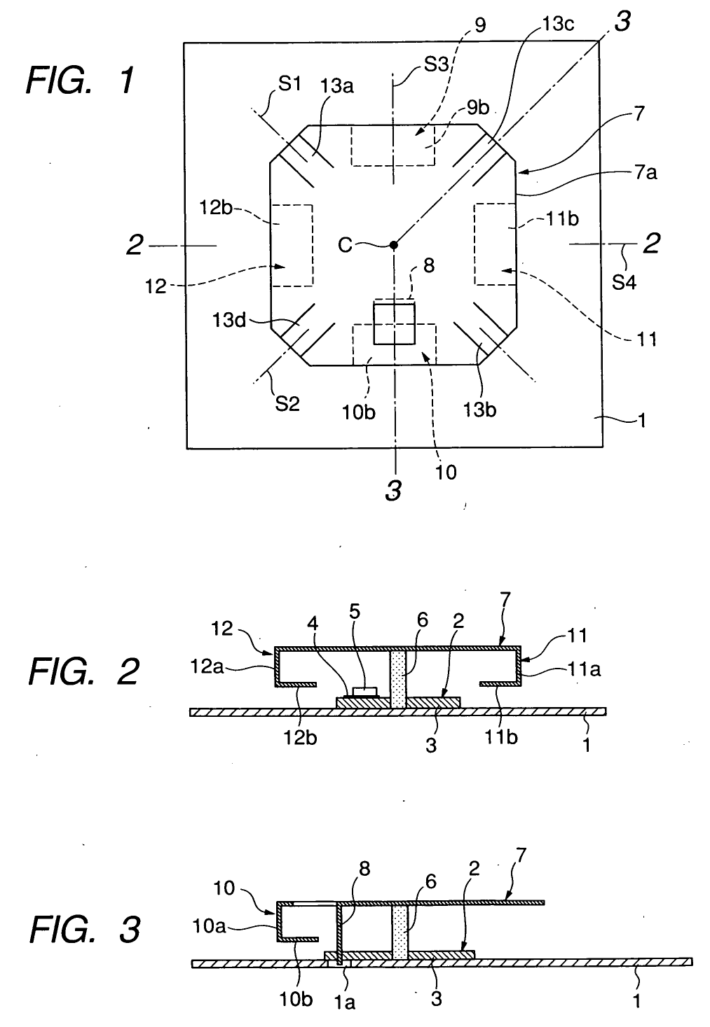

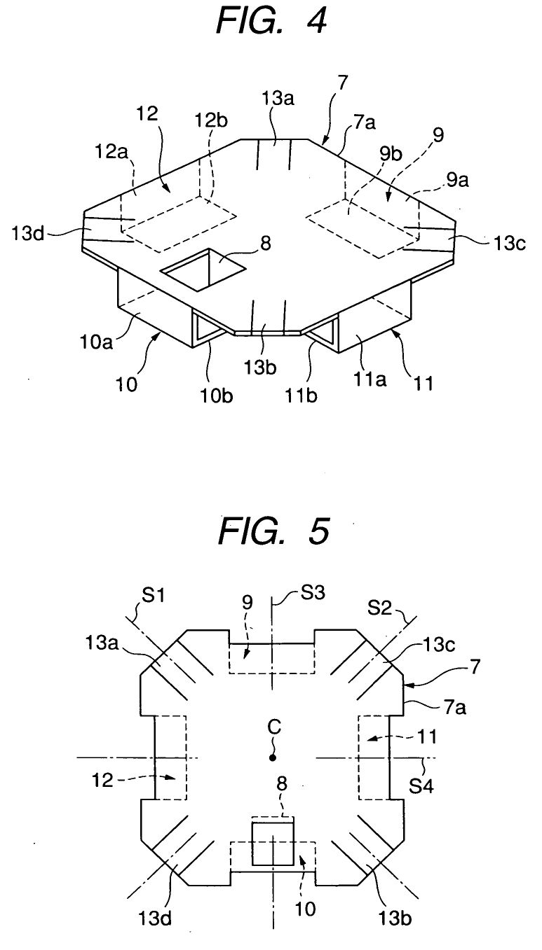

An antenna device according to the present invention will be described with reference to the accompanying drawings. FIG. 1 is a plan view of an antenna device according to a first embodiment of the present invention. FIG. 2 is a cross-sectional view taken along the line 2-2 of FIG. 1. FIG. 3 is a cross-sectional view taken along the line 3-3 of FIG. 1. FIG. 4 is a perspective view of a radiating conductor plate of the antenna device according to the first embodiment of the present invention. FIG. 5 is a plan view of a radiating conductor plate of an antenna device according to a second embodiment of the present invention.

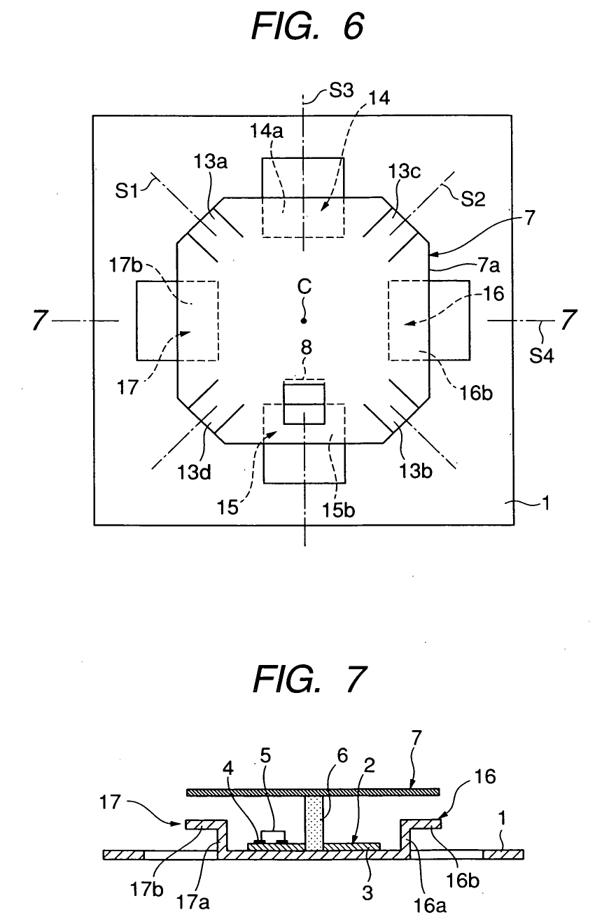

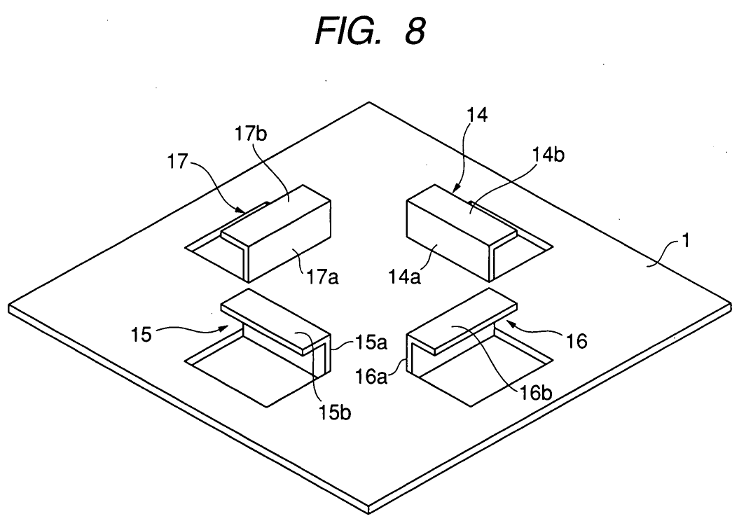

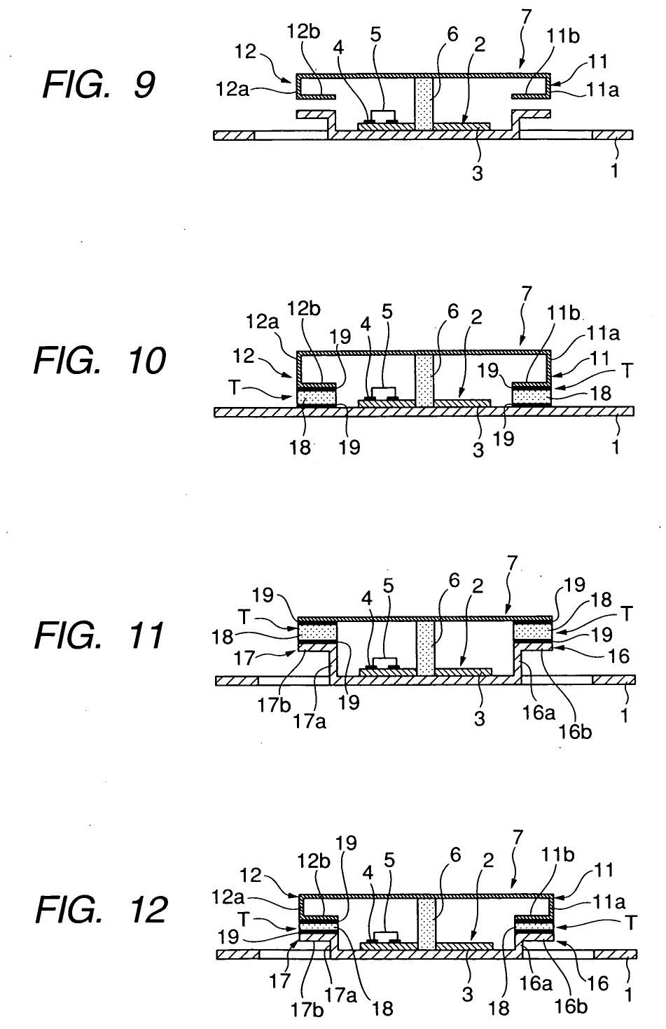

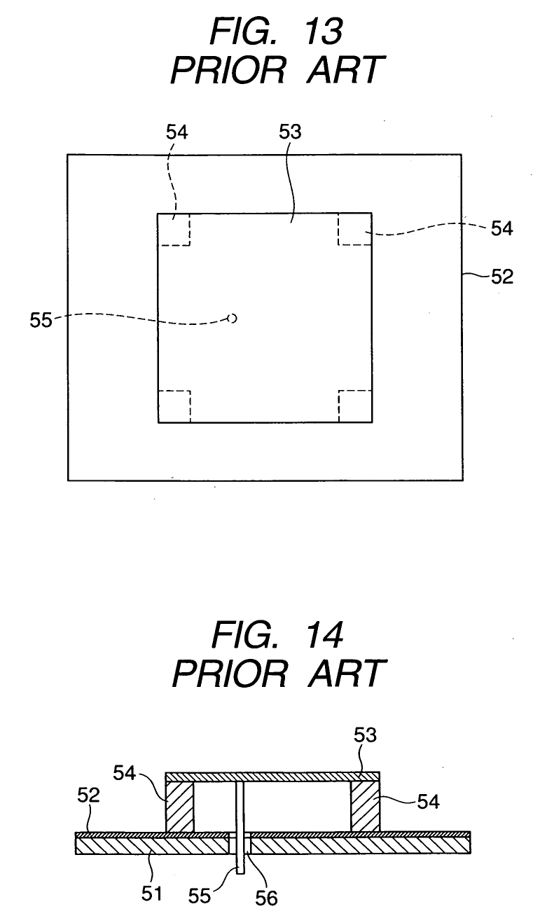

Further, FIG. 6 is a plan view of an antenna device according to a third embodiment of the present invention. FIG. 7 is a cross-sectional view taken along the line 7-7 of FIG. 6. FIG. 8 is a perspective view of a ground conductor plate of the antenna device according to the third embodiment of the present invention. FIG. 9 is a cross-sectional view of the main parts of an antenna device according to a fourth embodiment of the present invention. FIG. 10 is a cross-sectional view of the main parts of an antenna device according to a fifth embodiment of the present invention. FIG. 11 is a cross-sectional view of the main parts of an antenna device according to a sixth embodiment of the present invention. FIG. 12 is a cross-sectional view of the main parts of an antenna device according to a seventh embodiment of the present invention.

Hereinafter, the antenna device according to the first embodiment of the present invention will be described with reference to FIGS. 1 to 4. A ground conductor plate 1 composed of a metal plate, which is a ground conductor, is formed of a relatively large iron plate having a rectangular shape and has a release hole 1a at an appropriate position.

A rectangular circuit board 2 includes an insulating plate 3, a wiring pattern 4 provided in the insulating plate 3, and various electronic components 5 mounted on the insulating plate 3. A desired electric circuit comprising a filter circuit, an amplifying circuit, etc., is formed on the circuit board 2.

The circuit board 2 is mounted on almost the center of the ground conductor plate 1 by appropriate means.

A supporting member 6 is formed of a pillar portion made of an insulating material or a metallic material. The supporting member 6 passes through the circuit board 2 and is fixed to the center of the ground conductor plate 1.

As particularly shown in FIG. 1, an octagonal radiating conductor plate 7 composed of a metal plate has a feeding portion 8 composed of a bent piece bent downward, and an electric field is formed in the directions of first and second lines S1 and S2 that are orthogonal to each other and pass the center C of the radiating conductor plate 7. The first and second lines S1 and S2 are formed at an angle of 45° with respect to the feeding portion 8. In addition, a first electrical length is generated in the direction of the first line S1, and a second electrical length is generated in the direction of the second line S2. The first and second electrical lengths on the radiating conductor plate 7 are equal to each other.

Further, the radiating conductor plate 7 has four first extending portions 9, 10, 11, and 12 that are provided at the outer circumference of the radiating conductor plate 7, except the center thereof, on third and fourth lines S3 and S4 that are orthogonal to each other and pass the center C.

The third and fourth lines S3 and S4 are formed at an angle of 45° with respect to the first and second lines S1 and S2, respectively.

These four first extending portions 9 to 12 have leg portions 9a, 10a, 11a, and 12a bent downward from the radiating conductor plate 7 and plate-shaped electrode portions 9b, 10b, 11b, and 12b bent substantially at a right angle from end portions of the leg portions 9a to 12a, respectively. The leg portions 9a to 12a are bent downward at positions separated from the center C by the same distance and are provided along an outer circumferential portion 7a.

Furthermore, the intensity of an electric field of the radiating conductor plate 7 is strong at the outer circumferential portions of the radiating conductor plate 7 on the first and second lines S1 and S2. However, since the first extending portions 9 to 12 are separated from the first and second lines S1 and S2, a relatively weak electric filed is applied to the first extending portions 9 to 12.

Moreover, the radiating conductor plate 7 is provided with tongue pieces 13a, 13b, 13c, and 13d bendable by cut-out portions that are provided from the outer circumferential portion 7a toward the center C on the first and second lines S1 and S2.

Further, in the radiating conductor plate 7, the center thereof where the intensity of an electric field is weak is supported by the supporting member 6 to be mounted on the ground conductor plate 1, and the feeding portion 8 is soldered to the wiring pattern 4.

In this case, the feeding portion 8 is not electrically connected to the ground conductor plate 1 by the release hole 1a.

The radiating conductor plate 7 mounted on the circuit board 2 in this way is arranged parallel to the ground conductor plate 1 and the circuit board 2 at a predetermined gap therefrom, and the electrode portions 9b to 12b of the first extending portions 9 to 12 are arranged substantially parallel to the ground conductor plate 1 and opposite thereto at a close distance. In addition, capacitance is formed between the ground conductor plate 1 and the respective electrode portions 9b to 12b.

In the present embodiment, the areas of lower portions of the respective electrode portions 9b to 12b are equal to each other. However, the areas of the electrode portions 9b and 10b located on the third line S3 may be different from the areas of the electrode portions 11b and 12b located on the fourth line S4.

Further, the first electrical length of the radiating conductor plate 7 is determined by the length (the electrical length) of the radiating conductor plate 7 on the first line S1 and the magnitude of the capacitance formed by the first extending portions 9 and 10. In addition, the second electrical length of the radiating conductor plate 7 is determined by the length (the electrical length) of the radiating conductor plate 7 on the second line S2 and the magnitude of the capacitance formed by the first extending portions 11 and 12.

In the present embodiment, the electrical lengths of the radiating conductor plate 7 on the first and second lines S1 and S2 are equal to each other, and the capacitance formed by the first extending portions 9 and 10 on the third line S3 is equal to the capacitance formed by the first extending portions 11 and 12 on the fourth line S4. Therefore, the first and second electrical lengths on the first and second lines S1 and S2 are equal to each other, thereby obtaining a linearly polarized wave antenna device.

Further, when making the electrical lengths on the first and second lines S1 and S2 generated on the radiating conductor plate 7 different from each other, or when making the capacitance formed by the first extending portions 9 and 10 on the third line S3 different from the capacitance formed by the first extending portions 11 and 12 on the fourth line S4, the difference between the first and second electrical lengths on the first and second lines S1 and S2 occurs, thereby obtaining a circularly polarized wave antenna device.

Furthermore, when the radiating conductor plate 7 is mounted, the ground conductor plate 1 having an area larger than that of the radiating conductor plate 7 is arranged below the radiation conductor plate 7, and thus the circuit board 2 is arranged within a plane region of the radiating conductor plate 7 between the radiating conductor plate 7 and the ground conductor plate 1.

Therefore, in the antenna device having the above-mentioned structure, it is possible to adjust capacitance by bending the leg portions 9a to 12a and/or the electrode portions 9b to 12b of the first extending portions 9 to 12. In addition, it is possible to adjust capacitance by bending the tongue pieces 13a to 13d to change the gap from the ground conductor plate 1.

Further, in the above-mentioned embodiment, only one feeding portion is provided. However, it goes without saying that two feeding portions can be provided.

FIG. 5 illustrates an antenna device according to a second embodiment of the present invention. In the structure of the antenna device according to the second embodiment, the leg portions 9a to 12a of the first extending portions 9 to 12 are formed by cutting and bending at least a portion of the radiating conductor plate 7 and are recessed from the outer circumferential portion 7a of the radiating conductor plate 7 toward the center C.

In the present embodiment, structures other than the above-mentioned structure are the same as those in the first embodiment. In addition, the same components as those in the first embodiment have the same reference numerals, and a description thereof will be omitted.

FIGS. 6 to 8 illustrate an antenna device according to a third embodiment of the present invention. In the antenna device according to the third embodiment, the first extending portions 9 to 12 of the radiating conductor plate 7 in the first embodiment are not formed. Instead of them, second extending portions 14, 15, 16, and 17 are formed by cutting and bending the ground conductor plate 1, and the second extending portions 14, 15, 16, and 17 have leg portions 14a, 15a, 16a, and 17a bent toward the radiating conductor plate 7 and plate-shaped electrode portions 14b, 15b, 16b, and 17b bent substantially at a right angle from end portions of the leg portions 14a to 17a to be substantially parallel to the radiating conductor plate 7. The leg portions 14a to 17a are formed at the same distance from the supporting member 6.

In the third embodiment, capacitance is also formed between the second extending portions 14 to 17 and the radiating conductor plate 7, respectively, and it is possible to adjust the capacitance by bending the leg portions 14a to 17a and/or the electrode portions 14b to 17b of the second extending portions 14 to 17.

In the present embodiment, structures other than the above-mentioned structure are the same as those in the first embodiment. In addition, the same components as those in the first embodiment have the same reference numerals, and a description thereof will be omitted.

Further, FIG. 9 illustrates an antenna device according to a fourth embodiment of the present invention. In the fourth embodiment, the first extending portions 9 to 12 are provided in the radiating conductor plate 7, and the second extending portions 14 to 17 are provided in the ground conductor plate 1. In addition, capacitance is formed between the first extending portions 9 to 12 and the second extending portions 14 to 17, respectively.

In the present embodiment, structures other than the above-mentioned structure are the same as those in the first and third embodiments. In addition, the same components as those in the first and third embodiments have the same reference numerals, and a description thereof will be omitted.

Furthermore, FIG. 10 illustrates an antenna device according to a fifth embodiment of the present invention. The fifth embodiment has chip-type capacitors T each composed of a dielectric 18 made of an insulating material and electrodes 19 provided on both surfaces of the dielectric 18, and the chip-type capacitors T are arranged between the ground conductor plate 1 and the electrode portions 9b to 12b of the first extending portions 9 to 12, respectively. One electrode 19 of each of the chip-type capacitors T is connected to the respective first extending portions 9 to 12, and the other electrodes 19 of the chip-type capacitors T are connected to the ground conductor plate 1.

In this way, it is possible to increase capacitance and to reduce a resonance frequency. Further, it is possible to decrease the size of the radiating conductor plate 7.

In the present embodiment, structures other than the above-mentioned structure are the same as those in the first embodiment. In addition, the same components as those in the first embodiment have the same reference numerals, and a description thereof will be omitted.

Further, FIG. 11 illustrates an antenna device according to a sixth embodiment of the present invention. The sixth embodiment has the chip-type capacitors T each composed of the dielectric 18 made of an insulating material and the electrodes 19 provided on both surfaces of the dielectric 18, and the chip-type capacitors T are arranged between the radiating conductor plate 7 and the electrode portions 14b to 17b of the second extending portions 14 to 17, respectively. One electrode 19 of each of the chip-type capacitors T is connected to the respective second extending portions 14 to 17, and the other electrodes 19 of the chip-type capacitors T are connected to the radiating conductor plate 7.

In this way, it is possible to increase capacitance and to reduce a resonance frequency. Further, it is possible to decrease the size of the radiating conductor plate 7.

In the present embodiment, structures other than the above-mentioned structure are the same as those in the third embodiment. In addition, the same components as those in the third embodiment have the same reference numerals, and a description thereof will be omitted.

Further, FIG. 12 illustrates an antenna device according to a seventh embodiment of the present invention. The seventh embodiment has the chip-type capacitors T each composed of the dielectric 18 made of an insulating material and the electrodes 19 provided on both surfaces of the dielectric 18, and the chip-type capacitors T are arranged between the electrode portions 9b to 12b of the first extending portions 9 to 12 and the electrode portions 14b to 17b of the second extending portions 14 to 17, respectively. One electrode 19 of each of the chip-type capacitors T is connected to the respective first extending portions 9 to 12, and the other electrodes 19 of the chip-type capacitors T are connected to the second extending portions 14 to 17, respectively.

In this way, it is possible to increase capacitance and to reduce a resonance frequency. Further, it is possible to decrease the size of the radiating conductor plate 7.

In the present embodiment, structures other than the above-mentioned structure are the same as those in the first and third embodiments. In addition, the same components as those in the first and third embodiments have the same reference numerals, and a description thereof will be omitted.

Further, in the present embodiment, the size of each of the electrode portions 9b to 12b of the first extending portions 9 to 12 and the electrode portions 14b to 17b of the second extending portions 14 to 17 may be smaller than, equal to, or larger than the size of the chip-type capacitor T.

1. An antenna device comprising:
a ground conductor plate composed of a metal plate; and
a radiating conductor plate composed of a metal plate and arranged at a predetermined gap from the ground conductor plate,
wherein at least one of a plurality of first extending portions is provided in the radiating conductor plate to extend toward the ground conductor plate, and a plurality of second extending portions is provided in the ground conductor plate to extend toward the radiating conductor plate, and
wherein capacitance is formed between the first extending portions and the ground conductor plate, between the second extending portions and the radiating conductor plate, or between the first extending portions and the second extending portions, respectively.

2. The antenna device according to claim 1,
wherein the first extending portions each have a leg portion extending from the radiating conductor plate toward the ground conductor plate and an electrode portion provided at an end portion of the leg portion to extend substantially parallel to the ground conductor plate.

3. The antenna device according to claim 2,
wherein the leg portions of the first extending portions are provided along an outer circumference of the radiating conductor plate.

4. The antenna device according to claim 2,
wherein the leg portions of the first extending portions are formed by cutting and bending at least a portion of the radiating conductor plate to be recessed from an outer circumference of the radiating conductor plate toward a center thereof.

5. The antenna device according to claim 1,
wherein the second extending portions each have a leg portion extending from the ground conductor plate toward the radiating conductor plate and an electrode portion provided at an end portion of the leg portion to extend substantially parallel to the radiating conductor plate.

6. The antenna device according to claim 5,
wherein the second extending portions are formed by cutting and bending the ground conductor plate.

7. The antenna device according to claim 2, further comprising chip-type capacitors each composed of a dielectric and electrodes provided on both surfaces of the dielectric,
wherein the chip-type capacitors are arranged between the ground conductor plate and the electrode portions of the first extending portions, respectively, and
wherein one electrode of each of the chip-type capacitors is connected to the respective first extending portions, and the other electrodes of the chip-type capacitors are connected to the ground conductor plate.

8. The antenna device according to claim 5, further comprising chip-type capacitors each composed of a dielectric and electrodes provided on both surfaces of the dielectric,
wherein the chip-type capacitors are arranged between the radiating conductor plate and the electrode portions of the second extending portions, respectively, and
wherein one electrode of each of the chip-type capacitors is connected to the radiating conductor plate, and the other electrodes of the chip-type capacitors are connected to the respective electrode portions of the second extending portions.

9. The antenna device according to claim 1,
wherein the first extending portions each have a leg portion extending from the radiating conductor plate toward the ground conductor plate and an electrode portion provided at an end portion of the leg portion to extend substantially parallel to the ground conductor plate, and the second extending portions each have a leg portion extending from the ground conductor plate toward the radiating conductor plate and an electrode portion provided at an end portion of the leg portion to extend substantially parallel to the radiating conductor plate,
wherein the antenna device further comprises chip-type capacitors each composed of a dielectric and electrodes provided on both surfaces of the dielectric,
wherein the chip-type capacitors are arranged between the electrode portions of the first extending portions and the electrode portions of the second extending portions, respectively, and
wherein one electrode of each of the chip-type capacitors is connected to the respective electrode portions of the first extending portions, and the other electrodes of the chip-type capacitors are connected to the respective electrode portions of the second extending portions.

10. The antenna device according to claim 1,
wherein a supporting member is provided at a center of the radiating conductor plate, and the radiating conductor plate is supported above the ground conductor plate by the supporting member.

11. The antenna device according to claim 1,
wherein a circuit board having electronic components thereon is arranged between the ground conductor plate and the radiating conductor plate.

12. The antenna device according to claim 1,
wherein the radiating conductor plate is provided with tongue pieces each formed to be bendable by a cut-out portion that is provided from an outer circumference of the radiating conductor plate toward a center thereof, and capacitance is adjusted by bending the tongue pieces.
